(19) United States
(12) Patent Application Publication
(10) Pub. No.: US 2011/0116722 A1
(43) Pub. Date: May 19, 2011

(54) CODED STREAM REPRODUCTION DEVICE AND CODED STREAM REPRODUCTION METHOD

(76) Inventors: Yukinaga Seki, Kyoto (JP); Kenjiro Tsuda, Osaka (JP); Tatsuro Juri, Osaka (JP); Yuki Kobayashi, Osaka (JP); Takashi Masuno, Osaka (JP); Katsuo Saigo, Hyogo (JP); Hiroaki Shimazaki, Osaka (JP); Takuma Chiba, Osaka (JP)

(21) Appl. No.: 13/002,058

(22) PCT Filed: Jul. 2, 2009
(86) PCT No.: PCT/JP2009/003069

§ 371 Date: Dec. 30, 2010

(30) Foreign Application Priority Data
Jul. 4, 2008 (JP) 2008-175410

(51) Int. Cl. G06K 9/36

(52) U.S. Cl. 382/233

(57) ABSTRACT

Reproduction of a plurality of coded streams is switched smoothly without a large processing capability. A coded stream reproduction device (100) which reproduces one of a plurality of coded streams includes: an output selecting unit (109) which selects one of the coded streams; a data reading unit (102) which reads a first coded stream selected and a second coded stream not selected; a decoding unit (104) which decodes a first coded picture included in the first coded stream; and a corresponding data detecting unit (103) which detects a second coded picture from the second coded stream based on time information indicating a display time of the first decoded picture, the second coded picture being used for temporally-smooth switching of a display from the first coded stream to the second coded stream. The decoding unit (104) further decodes at least one of (i) the detected second coded picture, and (ii) a third coded picture to be referred to when decoding the second coded picture.

### TECHNICAL FIELD

The present invention relates to a coded stream reproduction device and a coded stream reproduction method, and, in particular, to a coded stream reproduction device and a coded stream reproduction method which smoothly switch the reproduction of coded streams with a relatively low processing capability.

### BACKGROUND ART

Along with an advancement in digital video processing techniques in recent years, the amount of image data that can be handled has been increasing, and compression coding of the image data through image coding is now essential. The representative examples of coding standards include Motion Picture Experts Group-2 (MPEG-2) and H.264/Advanced Video Coding (H.264/AVC).

In these coding standards, there are many cases where a predetermined number of pictures are managed and coded in a group. FIG. 7 shows an example of a Group of Pictures (GOP) structure that is a management unit of pictures in MPEG-2. Each GOP includes pictures that are an I-picture that is coded without reference to another picture, a P-picture that is predictive-coded with reference to a previous picture in the display order, and a B picture that is predictive-coded with reference to bidirectional pictures in the display order.

The recording format of, for example, a Blu-ray Disc Read Only Memory (BD-ROM) which records image data coded in accordance with MPEG-2 or H.264/AVC has a multi-angle function. The multi-angle function refers to a function where plurality pieces of video obtained by decoding each of the coded streams captured at the same time are switched and reproduced.

FIG. 8 is a diagram showing time relationship of respective coded streams in the case where coded streams were captured at the same time. Reference is made to a case as shown in FIG. 8 where switching is performed at a given timing from a first stream, which is a coded stream being reproduced, to a second stream, which is another coded stream.

In this case, in order to decode the picture at a subsequent time of another coded stream, it is necessary to read the coded stream from the I-picture that is located ahead in the display order from the picture, before starting the decoding. Furthermore, in H.264/AVC standard, it is possible to code a P-picture and a B-picture with reference to another picture passing over an I-picture. Therefore, it is necessary to read the coded stream by further going back to an Instantaneous Decoding Refresh (IDR) picture before the decoding. The IDR picture refers, to a picture which is defined not to be coded with reference to a previous picture.

In this way, a time, lag occurs between the time when switching of the coded streams is desired and the time when the coded streams are actually switched. As a result, it is not possible to achieve seamless switching of the coded streams. There is a disclosed technique for instantaneously achieving seamless reproduction at the time of switching of video of a plurality of coded streams (for example, see Patent Literature 1).

In the following, reference is made to the abstract of the operations of a conventional image decoding device disclosed in the Patent Literature 1, with reference to FIG. 9. FIG. 9 is a functional block diagram showing a functional structure of a conventional image decoding device 400 in the case where two coded streams captured at the same time are recorded. For example, two coded streams as shown in FIG. 8 are recorded in a recording medium 401.

First, the two coded streams read by a data reading unit 402 from the recording medium 401 are separated by a de-multiplexing unit 403 into a first stream and a second stream. The first stream is decoded by a first image decoding unit 404 and the second stream is decoded by a second image decoding unit 405, so that the decoded streams are held by an image accumulating unit 406. An output selecting unit 408 selects an output stream based on an operation of a user received by an operation receiving unit 409. An output switching unit 407 outputs, to a display unit 410, the stream selected by the output selecting unit 408 so that the display unit 410 displays video included in the stream.

In the case where the operation receiving unit 409 receives an operation, from the user, for changing the output stream, the output selecting unit 408 switches a stream to be selected as an output stream, based on the operation information. Here, the two streams are held by the image accumulating unit 406 after being decoded by the first image decoding unit 404 and the second image decoding unit 405; and thus, it is possible to instantaneously switch the output.

### CITATION LIST

### Patent Literature

PTL 1
Japanese Patent Application Publication No. 2006-217634

### SUMMARY OF INVENTION

### Technical Problem

However, for the conventional technique, a problem exists where a large processing capability is required in order to smoothly switch the reproduction of a plurality of coded streams. The following describes the details of the problem.

In the conventional technique disclosed by the Patent Literature 1, it is necessary to decode a plurality of coded streams at the same time. Therefore, achieving a seamless switching of N coded streams requires decoding capability N times as high as that of a decoding device which can decode only a single coded stream. In addition, the buffer which holds images also needs to have capacity N times as large as the capacity of a buffer of such a decoding device.

It is assumed that, as shown in FIG. 10, there are coded streams captured at different frame rates. FIG. 10 is a diagram showing time relationship of respective coded streams obtained when a coded stream of 60 frame per second (fps) and a coded stream of 240 fps were captured at the same time.

In this case, in order to seamlessly switch coded streams using the conventional technique disclosed in the Patent Literature 1, the coded stream captured at 240 fps needs to be decoded at 240 fps to match the time relationship of the two coded streams. In other words, the coded stream captured at frame rate N times as fast as a normal frame rate needs to be decoded at a speed N times as fast as the normal speed.

As described, a decoding device needs to have a large processing capability in order to achieve seamless switching of coded streams using the conventional technique.

The present invention has been conceived in view of the conventional problem, and has an object to provide a coded stream reproduction device and a coded stream reproduction method which smoothly switch the reproduction of coded streams without requiring a large processing capability.

### Solution to Problem

In order to achieve the above object, a coded stream reproduction device according to an aspect of the present invention is a coded stream reproduction device which reproduces one of a plurality of coded streams. The coded stream reproduction device includes: a selecting unit which selects one of the coded streams; an obtaining unit which obtains a first coded stream and a second coded stream from the coded streams, the first coded stream being selected by the selecting unit, the second coded stream not being selected by the selecting unit; a decoding unit which decodes a first coded picture included in the first coded stream to generate a first decoded picture; and a corresponding data detecting unit which detects a second coded picture from the second coded stream based on time information indicating a display time of the first decoded picture, the second coded picture being used for temporally-smooth switching of a display from the first coded stream to the second coded stream, wherein the decoding unit decodes at least one of (i) the second coded picture detected by the corresponding data detecting unit and (ii) a third coded picture to be referred to when decoding the second coded picture.

With this, while the first coded stream is being reproduced, the second coded picture is detected from the second coded stream and the detected second, coded picture and the third coded picture are decoded. Thus, it is possible to smoothly switch the reproduction of coded streams. Here, not all of the pictures in the second coded stream are decoded; and thus, the decoding unit does not require a large processing capability.

Further, it may be that the coded stream reproduction device further includes: an accumulating unit which accumulates the decoded picture generated by decoding by the decoding unit; and an output unit which reads, from the accumulating unit, the decoded picture generated from the coded stream selected by the selecting unit and to output the read decoded picture, wherein the output unit outputs a second decoded picture generated by decoding the second coded picture corresponding to the first decoded picture that is being output when the selecting unit selects the second coded stream.

With this, the second decoded picture, corresponding to the first coded picture being output at the time of switching of the coded streams, is output. Thus, it is possible to smoothly switch the reproduction of coded streams.

Further, it may be that the decoding unit generates the second decoded picture by decoding the second coded picture, in the case where the second coded picture is not decoded when the selecting unit selects the second coded stream, the second coded picture corresponding to the first decoded picture output by the output unit.

With this, in the case where the coded picture to be output has not been obtained at the time of output, the output is performed after decoding the picture. Thus, it is possible to smoothly switch the reproduction of coded streams.

Further, it may be that the corresponding data detecting unit detects, as the second coded picture, a picture having time information indicating a time within a predetermined period from the display time indicated by the time information of the first decoded picture.

With this, a coded picture having a display time within a predetermined period from the display time of the decoded picture being output is detected and decoded. This allows more smooth reproduction of coded streams.

Further, it may be that the corresponding data detecting unit detects, as the second coded picture, a picture having time information indicating a time that is later than and closest to the display time indicated by the time information of the first decoded picture.

With this, a picture immediately after the decoded picture being output can be output; and thus, it is possible to seamlessly switch the reproduction of coded streams.

Further, it may be that the corresponding data detecting unit detects, as the second coded picture, a picture having time information indicating a time within a period from the display time indicated by the time information of the first decoded picture, the period indicating a period between continuous coded pictures of the first coded stream or the second coded stream.

With this, it is possible to more smoothly switch the reproduction of coded streams.

Further, it may be that the first coded stream has a frame rate lower than a frame rate of the second coded stream, and the corresponding data detecting unit detects, as the second coded picture, a picture having time information indicating a time later than the display time and within a period from the display time, the display time being indicated by the time information of the first decoded picture, the period being a period between continuous coded pictures of the first coded stream.

With this, it is possible to more smoothly switch the reproduction of coded streams.

Further, it may be that the decoding unit decodes the second coded picture in the case where the second coded picture is a reference picture to be referred to when another coded picture is decoded.

With this, in the case where the second coded picture is not a reference picture, the second coded picture is not decoded; and thus, it is possible to reduce the processing load of the decoding unit.

Further, it may be that the decoding unit decodes the third coded picture in the case where the second coded picture is not a reference picture to be referred to, when another coded picture is decoded and the third coded picture has not been decoded.

With this, in the case where the second coded picture is not a reference picture, the second coded picture is not decoded, and the third coded picture, which is referred to at the time of decoding of the second coded picture, is decoded. Thus, when it is necessary to decode a coded picture that refers to the third coded picture, the coded picture can be immediately decoded.

The present invention can be implemented not only as a coded stream reproduction device, but also as a method including processing units included in the coded stream reproduction device as steps. In addition, the present invention may be implemented as a program causing a computer to execute the steps. Furthermore, the present invention may be implemented as a computer-readable recording medium such as a Compact Disc-ROM (CD-ROM), a Digital Versatile Disc-ROM (DVD-ROM), or a BD-ROM which store the program, as well as information, data or a signal indicating the program. Such program, information, data, or signal may be distributed via a communications network such as the Internet.

Part or all of the elements included in the coded stream reproduction device may be in a form of a single system Large Scale Integration (LSI). The system LSI is a ultra-multifunctional LSI which is produced by integrating a plurality of constitutional units on a single chip. More specifically, the system LSI is a computer system including, for example, a microprocessor, a ROM, and a Random Access Memory (RAM).

### Advantageous Effects of Invention

With the coded stream reproduction device according to the present invention, it is possible to smoothly switch the reproduction of a plurality of coded streams without requiring a large processing capability.

### BRIEF DESCRIPTION OF DRAWINGS

FIG. 1 is a diagram showing a structure of an MPEG2-TS that is an example of a coded stream according to an embodiment of the present invention.

FIG. 2 is a block diagram showing an example of a functional structure of a coded stream reproduction device according to the embodiment of the present invention.

FIG. 3 is a diagram showing an example of streams reproduced by the coded stream reproduction device according to the embodiment of the present invention.

FIG. 4 is a diagram showing an example of streams reproduced by the coded stream reproduction device according to the embodiment of the present invention.

FIG. 5 is a flowchart showing an example of the reproduction operation performed by the coded stream reproduction device according to the embodiment of the present invention.

FIG. 6 is a flowchart showing an example of decoding processing of a coded stream that is not being reproduced, out of the reproduction operation performed by the coded stream reproduction device according to the embodiment of the present invention.

FIG. 7 is a diagram showing an example of a GOP structure.

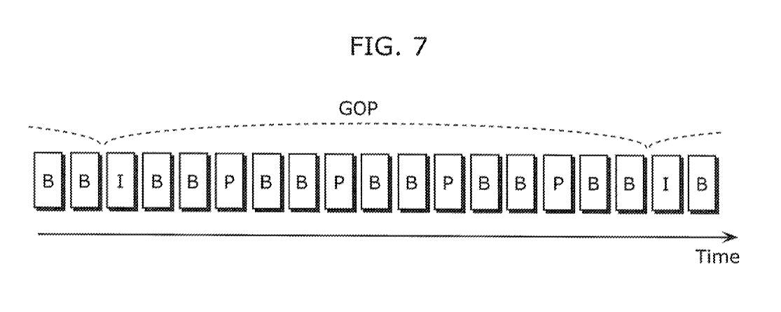

FIG. 8 is a diagram showing time relationship between two coded streams having a same frame rate.

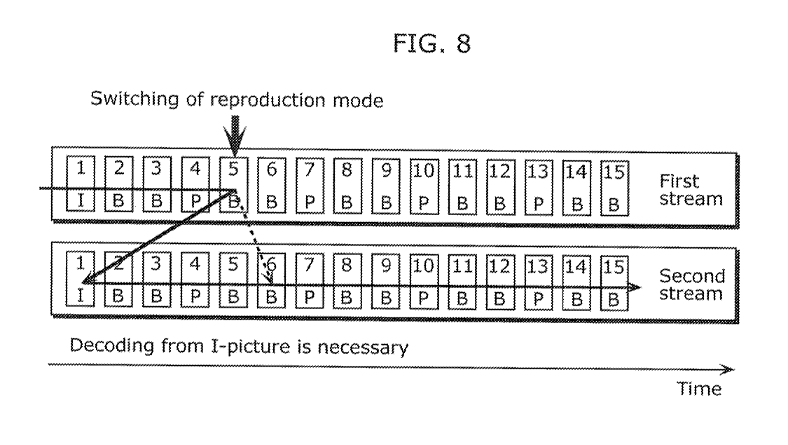

FIG. 9 is a block diagram showing a functional structure of a conventional image decoding device.

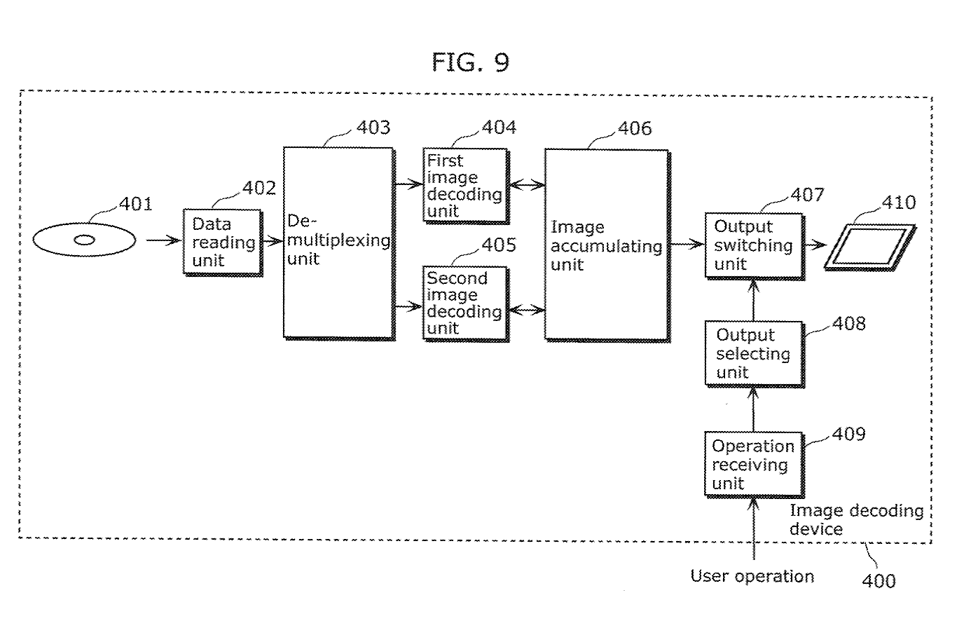

FIG. 10 is a diagram showing time relationship between two coded streams having different frame rates.

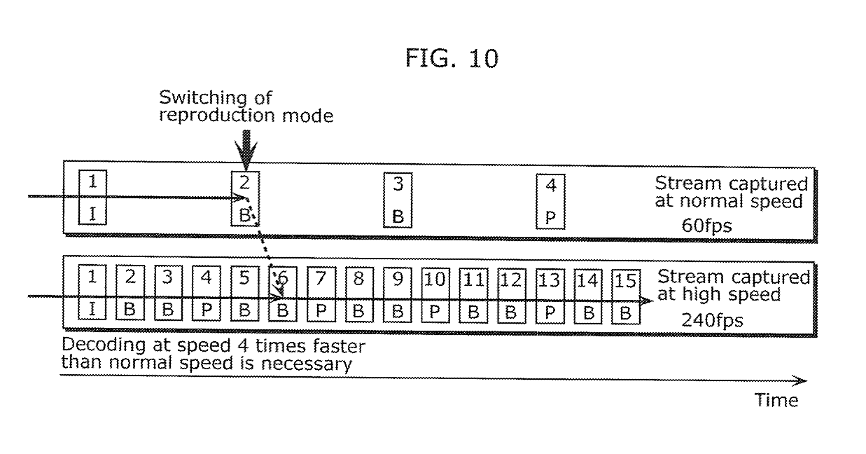

### DESCRIPTION OF EMBODIMENTS

Hereinafter, reference is made to an embodiment of a coded stream reproduction device according to the present invention, with reference to the drawings.

### Embodiment 1

A coded stream reproduction device according to the present embodiment reproduces one of coded streams recorded on a recording medium that is externally or internally provided in a removable manner. More specifically, it is assumed that the coded stream reproduction device reads coded streams from the recording medium, decodes the read coded streams, and outputs the decoded pictures generated by the decoding of the coded streams to an external device such as a display.

First, in the present embodiment, reference is made to a coded stream read by the coded stream reproduction device from the recording medium, with reference to the drawings. In the present embodiment, coded streams multiplexed in accordance with MPEG2-Transport Stream (TS) are read from the recording medium; however, it may also be that coded streams, multiplexed using a multiplexing scheme including MPEG2-Program Stream (PS) are read. Furthermore, in the present embodiment, image data included in coded streams are coded in accordance with H.264/AVC; however, the coding scheme applied to the image data may be any other coding schemes including MPEG-2, VC-1.

(Structure of MPEG2-TS)

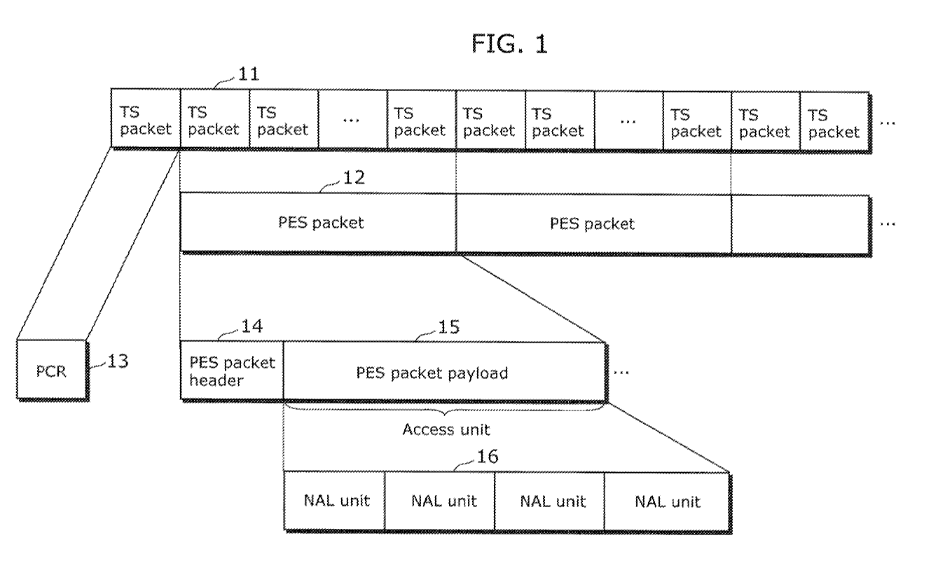

FIG. 1 is a diagram showing a structure of an MPEG2-TS that is an example of a coded stream according to the present embodiment and is recorded on a recording medium. The MPEG2-TS shown in FIG. 1 includes packets of fixed length, referred to as TS packets 11. Packetized Elementary Stream (PES) packets 12 storing data of video and audio, reference clock information referred to as Program Clock Reference (PCR) 13 and the like are transmitted with the TS packets 11.

A PES packet header 14 of the PES packet 12 stores: Presentation Time Stamp (PTS) and Decoding Time Stamp (DTS) which respectively represent timings of displaying and decoding of an access unit that is a decoding unit of video or audio stored in a PES packet payload 15.

Each access unit of video data includes coded data of one picture. More specifically, each access unit includes unit data referred to as Network Abstraction Layer (NAL) units 16 storing: image data of a picture included in a coded stream, a parameter, such as Sequence Parameter Set (SPS) or Picture Parameter Set (PPS), used for decoding images, and information such as Supplemental Enhancement Information (SEI) including additional information such as timing information of each picture. The header of each NAL unit 16 includes information (nal_ref_idc) which indicates whether or not the NAL unit includes data to be referred to by another NAL unit.

In the following, reference is made to a coded stream reproduction device according to the present embodiment, with reference to the drawings.

### (Structure of a Coded Stream Reproduction Device 100)

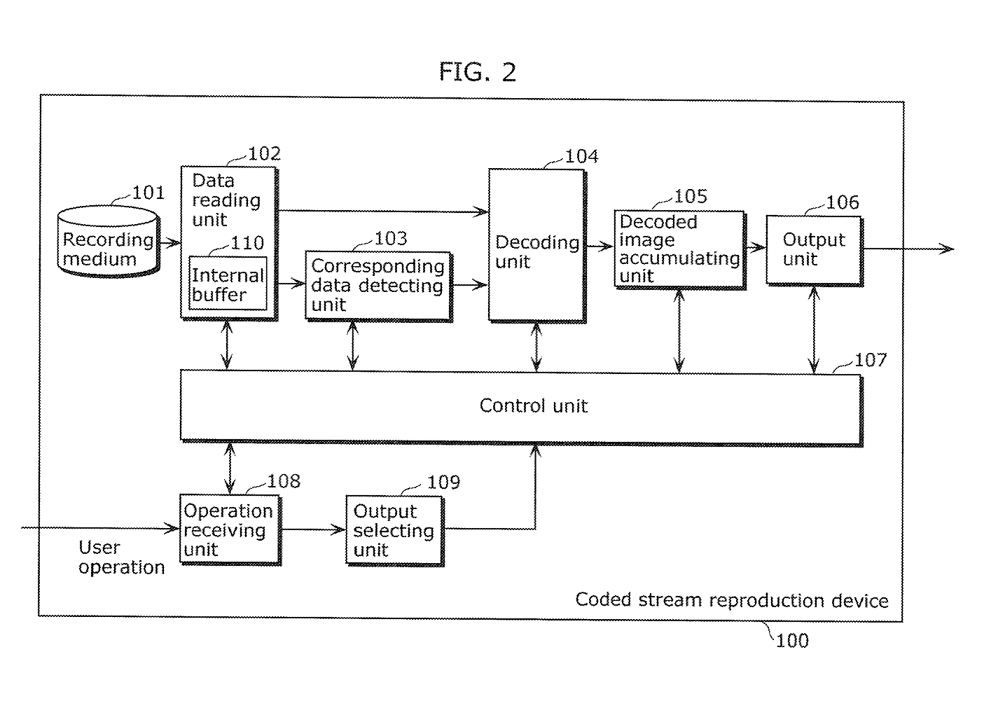

FIG. 2 is a block diagram showing an example of a structure of the coded stream reproduction device 100 according to the present embodiment. The coded stream reproduction device 100 in FIG. 2 includes: a recording medium 101; a data reading unit 102; a corresponding data detecting unit 103; a decoding unit 104; a decoded image accumulating unit 105; an output unit 106; a control unit 107; an operation receiving unit 108; and an output selecting unit 109.

In the present embodiment, a coded stream selected as a stream to be reproduced is referred to as stream A, and another coded stream is referred to as stream B. At the beginning of the operation of the coded stream reproduction device 100, the stream A is selected as a stream to be reproduced. Later, the stream to be reproduced is changed from the stream A to the stream B based on a user's operation or the like.

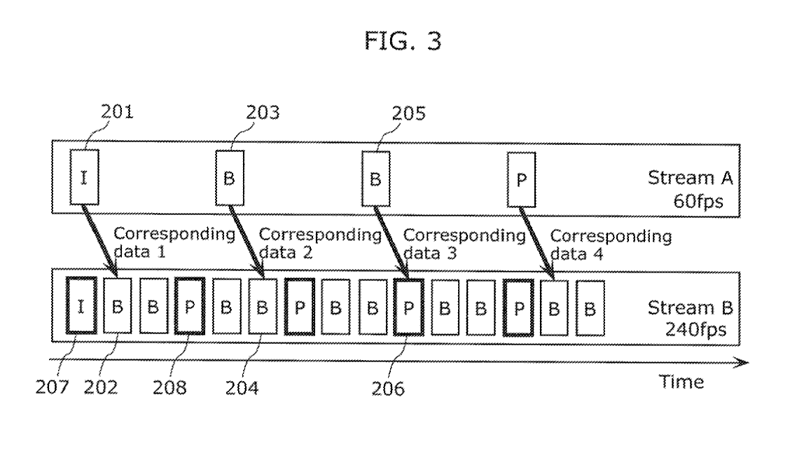

In the following description, a case will be described where a coded stream, coded in accordance with H.264 standard and having a frame rate of 60 fps as shown in FIG. 3, is selected as the stream A, and a coded stream, coded in accordance with H.264 standard and having a frame rate of 240 fps, is selected as the stream B.

The recording medium 101 is a recording unit that is capable of accumulating a plurality of coded streams. The recording medium 101, for example, stores the streams A and B shown in FIG. 3. The recording medium 101 mainly stores coded streams, but may accumulate any kind of data including still image data and music data. The recording medium 101 may be a memory included in the coded stream reproduction device 100, and also may be a removable recording medium such as a DVD-RAM, a BD-RAM, or an SD memory card.

The data reading unit 102 is an example of an obtaining unit which obtains the coded stream selected by the output selecting unit 109 and the coded stream not selected by the output selecting unit 109. More specifically, the data reading unit 102 reads, from the recording medium 101, the stream A that is a coded stream being reproduced and the stream B that is another coded stream among a plurality of coded streams stored in the recording medium 101. For example, the data reading unit 102 includes an internal buffer 110, reads, based on a control by the control unit 107, image data corresponding to one picture from the streams A and B stored in the recording medium 101, and accumulates the read image data into the internal buffer 110.

The internal buffer 110 is a memory which is used when the control unit 107 reads image data, and which temporarily stores the read image data. The information stored temporarily in the internal buffer 110 is mainly coded image data; however, a control signal or the like may be stored. The internal buffer 110 may be any recordable units including a Dynamic RAM (DRAM), a Static RAM (SRAM), a flush memory, and a ferroelectric memory.

The corresponding data detecting unit 103 detects, from the stream B, a corresponding coded picture used for temporally-smooth switching of a display from the stream A to the stream B, based on time information of a decoded picture in the stream A that is being output by the output unit 106. For example, the corresponding data detecting unit 103 detects a coded picture as a corresponding coded picture from the stream B. The coded picture here has time information indicating a time within a predetermined period from the display time indicated by the time information of the decoded picture corresponding to the stream A that is being output by the output unit 106.

The predetermined time period is, for example, a time period between continuous coded pictures of the stream A or the stream B, that is, a period indicated by an inverse number of the frame rate of the stream A or the stream B. As shown in FIG. 3, in the case where the frame rate of the stream A is different from that of the stream B, a picture included between continuous pictures of the stream A having a lower frame rate is detected as a corresponding coded picture from the stream B.

For example, in the example shown in FIG. 3, pictures (corresponding coded pictures) represented by corresponding data which corresponds to the I-picture 201 are four pictures included between the I-picture 207 and the B-picture 204. Alternatively, the picture represented by the corresponding data which corresponds to the I-picture 201 may be the I-Picture 207 that has the same time.

In the present embodiment, as a preferred example, the corresponding data detecting unit 103 detects a coded picture as a corresponding coded picture. The coded picture here has time information indicating time later than and closest to the display time indicated by the time information of the coded picture included in the stream A that is being output by the output unit 106. More specifically, the corresponding data detecting unit 103 detects, based on the control by the control unit 107, image data as corresponding data from among image data corresponding to one picture included in the stream B read by the data reading unit 102. The image data detected here is image data having display time that is later than and closest to the display time included in the image data corresponding to the decoded picture that is being output by the output unit 106.

For example, in the example shown in FIG. 3, the picture (corresponding coded picture) represented by the corresponding data which corresponds to the I-picture 201 is the B-picture 202. The picture represented by the corresponding data which corresponds to the B-picture 203 is the B-picture 204. The picture represented by the corresponding data which corresponds to the B-picture 205 is the P-picture 206.

The corresponding data detecting unit 103 is not limited to the structure where corresponding data is detected based on the display time of the decoded picture being output by the output unit 106. The corresponding data detecting unit 103 may detect the corresponding data by using a decoded picture accumulated in the decoded image accumulating unit 105. Alternatively, the corresponding data detecting unit 103 may have any structures, including directly detecting the corresponding data from a coded stream stored in the recording medium 101.

The decoding unit 104 decodes coded pictures included in the stream A read out by the data reading unit 102 to generate decoded pictures. Furthermore, the decoding unit 104 decodes at least one of the corresponding coded picture detected by the corresponding data detecting unit 103 and a picture that is to be referred to when decoding the corresponding coded picture.

More specifically, the decoding unit 104 (i) generates System Time Clock (STC) based on the PCR in accordance with the control of the control unit 107, (ii) decodes image data at the time when the generated STC matches with the DTS included in the image data corresponding to one picture included in the steam A read out by the data reading unit 102 or the DTS included in the corresponding data detected by the corresponding data detecting unit 103, and then (iii) outputs, to the decoded image accumulating unit 105, the decoded image generated from the decoding.

When the corresponding data is reference image data which indicates a reference picture that is to be referred to at the time of decoding of another picture, the decoding unit 104 decodes the corresponding data. For example, in the case where the corresponding data represents an I-picture or a P-picture, the decoding unit 104 decodes the corresponding data.

On the other hand, in the case where a required reference picture has not been decoded at the time of decoding of the corresponding data, the decoding unit 104 decodes the image data indicating the coded picture that is referred to by the corresponding data. For example, in the case where the corresponding data is a non-reference image data that indicates a non-reference picture that is not to be referred to at the time of decoding of another picture, the decoding unit 104 decodes image data that is to be referred to at the time of decoding of the corresponding data. For example, in the case where the corresponding data represents B-picture, the decoding unit 104 decodes the I-picture and the P-picture that are referred to at the time of decoding of the B-picture.

The decoded image accumulating unit 105 accumulates the decoded picture generated by the decoding unit 104. The decoded image accumulating unit 105 also accumulates the reference picture referred to at the time of decoding of the corresponding coded picture included in the stream B. More specifically, the decoded image accumulating unit 105 is a memory which accumulates the decoded picture output by the decoding unit 104, based on the control of the control unit 107. For example, the decoded image accumulating unit 105 may be any recordable units including a DRAM, an SRAM, a flush memory, and a ferroelectric memory. As described, not only the decoded pictures included in the stream A that is being reproduced, but also the decoded pictures included in the stream B that is not being reproduced are accumulated. This allows smooth switching of the display at the time of switching of the streams.

The output unit 106 reads the decoded picture generated from the coded stream that is being reproduced and outputs the read decoded picture to an external device. When the output selecting unit 109 selects a coded stream different from the coded stream that is being reproduced, the output unit 106 reads, from the decoded image accumulating unit 105, the decoded picture generated from the coded stream selected by the output selecting unit 109, and outputs the read decoded picture.

More specifically, the output unit 106 reads a decoded picture corresponding to the stream A selected by the output selecting unit 109 from among the decoded pictures accumulated in the decoded image accumulating unit 105, and outputs the read decoded picture to an external device, based on the control of the control unit 107. In the case where the output selecting unit 109 selects the stream B, the output unit 106 reads the decoded picture corresponding to the stream B from the decoded image accumulating unit 105 and outputs the read decoded picture to an external device.

The output unit 106 determines whether or not the decoded picture to be output is accumulated by the decoded image accumulating unit 105. More specifically, the output unit 106 makes the determination using the PTS and the STC included in the decoded image data. The decoded picture to be output is a decoded picture generated by decoding the coded picture of the stream B corresponding to the decoded picture of the stream A that is being output by the output unit 106. In the case where the decoded picture to be output is not accumulated, the output unit 106 causes, via the control unit 107, the decoding unit 104 to decode the corresponding data so as to generate the decoded picture to be output.

The external device may be any device including a Plasma Display Panel (PDP), a liquid crystal display, or an organic EL display device, as long as the device includes a display unit capable of displaying decoded pictures. The information used for the determination is not limited to the PTS and the STC, but may be any information as long as the information can match the image data information to be output and the decoded picture accumulated in the decoded image accumulating unit 105.

The control unit 107 controls the overall operation of the coded stream reproduction device 100 by controlling the operations of the data reading unit 102, the corresponding data detecting unit 103, the decoding unit 104, the decoded image accumulating unit 105, the output unit 106, the operation receiving unit 108, and the output selecting unit 109. The control unit 107 can be implemented as a semiconductor element or the like, and may be formed of only hardware. Alternatively, the control unit 107 may be implemented by a combination of hardware and software. The control unit 107 may also be formed of a plurality of devices. In the case where the control unit 107 is implemented as software, it can be achieved with a use of a microprocessor.

The operation receiving unit 108 is capable of receiving various instructions from a user as operating signals. The operation receiving unit 108 outputs the received operating signals to the control unit 107. In the case where the received operating signal is an operating signal for switching the coded streams to be output to an external device from the output unit 106, the operation receiving unit 108 outputs the operating signal to the output selecting unit 109. For example, the operation receiving unit 108 may detect an operating signal upon reception of an operating signal transmitted from a remote controller. The operating receiving unit 108 may have any structures, for example, including a button or the like that can be pressed so that an operating signal is detected when the button is pressed.

When the output selecting unit 109 detects the operating signal output from the operation receiving unit 108, the output selecting unit 109 outputs, to the control unit 107, a selecting signal for selecting a coded stream to be output from the output unit 106, based on the operating signal.

Next, reference is made to an example of the operation of the corresponding data detecting unit 103 included in the coded stream reproduction device 100 according to the present embodiment. More specifically, reference is made to an example of a processing for detecting corresponding data of the stream B.

The time relationship regarding the display time of image data corresponding to one picture included in a coded stream can be determined based on the PTS representing the display time in the image data. Assumed a case where time information of respective streams are synchronized at the time of detecting of the corresponding coded picture represented by the corresponding data which corresponds to the I-picture 201 shown in FIG. 3. In this case, it is sufficient to detect, from the stream B, image data having PTS that is later than and closest to the PTS of the image data corresponding to the I-picture 201. In other words, the corresponding data detecting unit 103 detects the B-picture 202 as the corresponding coded picture of the I-picture 201.

If the frame rate is constant, the intervals of the PTS of the continuous pictures in the display order are also constant and thus, it is possible to calculate the PTS of each picture in a stream based on the PTS in the previously read image data. Therefore, it is possible to determine the PTS to be included in the corresponding data at the time of reading of the PTS of the I-picture 201 by calculating the PTS of each picture in the stream 8 in advance based on the PTS in the image data previously read from the stream B.

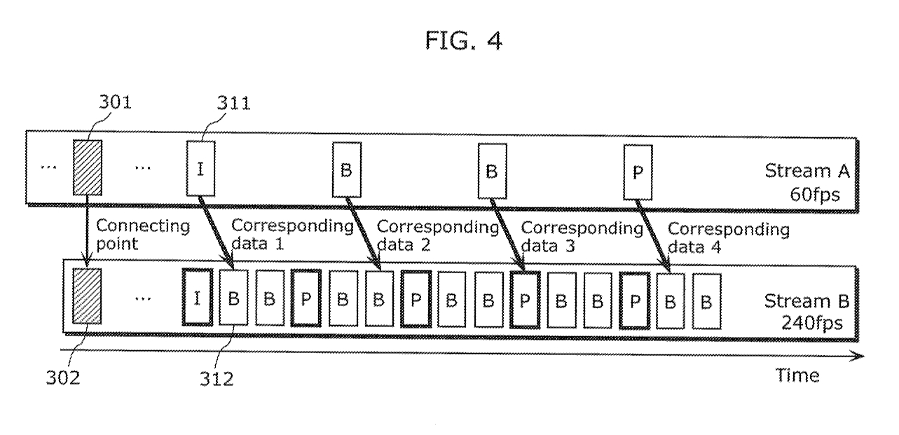

On the other hand, in the case where the time information in respective streams are not synchronized and only the connecting point of the streams is, specified, the corresponding data detecting unit 103 calculates the displacement between the time information of the respective streams in advance. FIG. 4 shows an example where time information of respective streams are not synchronized.

In this case, the corresponding data detecting unit 103 calculates the value of the PTS_Offset in advance and holds the value. The PTS_Offset is a value obtained by subtracting the PTS of the display picture 302 of the stream B from the PTS of the display picture 301 of the stream A at the connecting point of the streams. Here, when the corresponding coded picture represented by the corresponding data which corresponds to the I-picture 311 is to be detected, it is sufficient to detect, from the stream B, image data having the PTS later than and closest to the PTS obtained by subtracting the PTS_Offset value from the PTS of the image data corresponding to the I-picture 311. In other words, the corresponding data detecting unit 103 detects the B-picture 312 as the corresponding coded picture of the I-picture 311.

Hereinafter, it is assumed that the time information of respective streams are synchronized, for ease of description. However, even in the case where the time information of the respective streams are not synchronized, time relationship for the display time of image data of respective streams can be determined by the above method in the similar manner.

In the case where a plurality of access units is multiplexed into a single PES packet, the DTS and the PTS of the packet header corresponds to the first access unit in the PES packet. In this case, the decoding time and the display time of the subsequent access units in the PES packet are calculated from a Picture Order Count (POC) value that is a parameter representing display order, or at least one of information of Buffering Period_SEI (BP_SEI) and Picture Timing_SEI (PT_SEI) in the SEI.

In the case where the decoding time and the display time of the access unit is displayed by the POC value, a given relationship is established between the POC value and the display time of the access unit; and thus, the decoding time and the display time can be calculated from the POC value. The BP_SEI is included in a certain access unit such as a head of a video sequence. The PT_SEI is a value included in each of the access units. The PT_SEI includes a differential value of the decoding time between an access unit having the PT_SEI and an access unit that has BP_SEI and immediately precedes the access unit having the PT_SEI, and a differential value between the decoding time and the display time in each access unit; and thus, the decoding time and the display time of each access unit can be calculated.

Next, reference is made to an example of the operations of the decoding unit 104 and the control unit 107 included in the coded stream reproduction device 100 according to the present embodiment. More specifically, reference is made to an example of processing for decoding corresponding data detected by the corresponding data detecting unit 103.

As described, the decoding unit 104 decodes different data depending on whether or not the corresponding data is reference image data and whether or not image data that is referred to when decoding the corresponding data has been generated.

Here, whether or not the corresponding data can be reference image data can be determined from a flag referred to as nal_ref_idc to stored in the header of a NAL unit out of the data in the corresponding data. When the nal_ref_idc is 1, it is determined that the corresponding data is reference image data. When the nal_ref_idc is 0, it is determined that the corresponding data is not reference image data. The determination is, for example, made by the decoding unit 104.

For example, in FIG. 3, in the case where the corresponding data detecting unit 103 detects, as the corresponding data, image data indicating the B-picture 202 and where the decoding unit 104 determines from the nal_ref_idc of the image data indicating the B-picture 202 that the B-picture 202 is not required for decoding another image data, the decoding unit 104 decodes image data indicating the I-picture 207 and image data indicating the P-picture 208, and outputs the generated two decoded pictures to the decoded picture accumulating unit 105.

In the case where the corresponding data detecting unit 103 detects, as the corresponding data, the image data indicating the P-picture 206 and where the decoding unit 104 determines from the nal_ref_idc of the image data indicating the P-picture 206 that the P-picture 206 is reference image data, the decoding unit 104 decodes the P-picture 206 and outputs the decoded picture to the decoded image accumulating unit 105.

It may be that in the case of the image data indicating the B-picture 202, the image data indicating the I-picture 207, the image data indicating the P-picture 208 and the image data indicating the B-picture 202 are decoded and the three decoded pictures are output to the decoded image accumulating unit 105. It may also be that only the image data corresponding to the B-picture 202 is decoded and the generated decoded picture is output to the decoded image accumulating unit 105. In this case, the image data corresponding to the B-picture 202 is decoded, which allows higher efficiency of switching of the streams to be reproduced.

(Overall Operation of the Coded Stream Reproduction Device 100)

In the following, reference is made to the operation of the coded stream reproduction device 100 thus structured, with reference to the drawings.

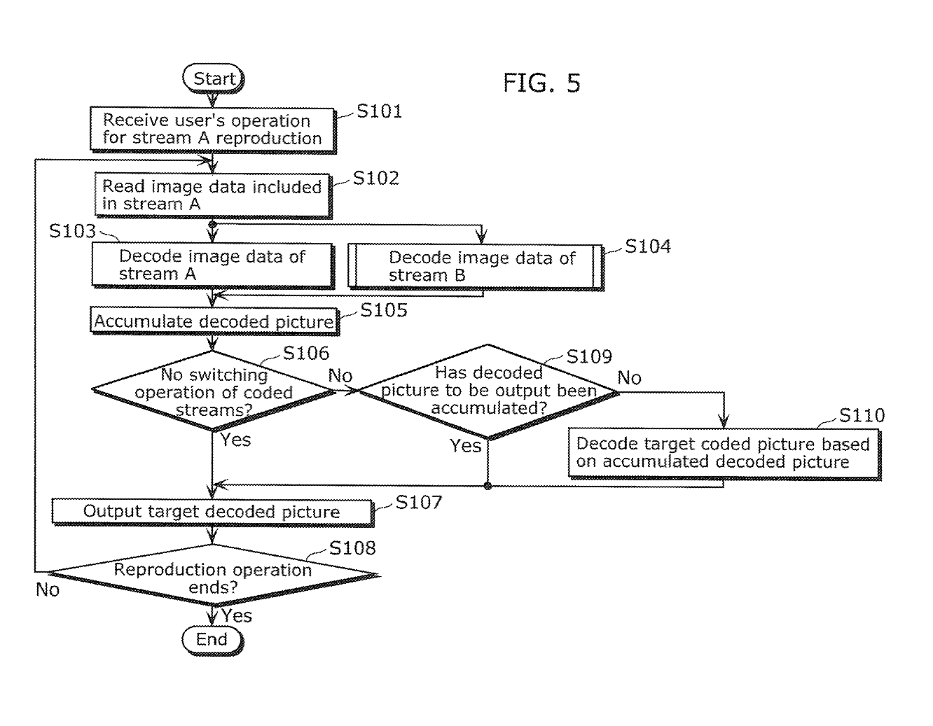

FIG. 5 is a flowchart showing an example of the reproduction operation of the coded stream reproduction device 100 according to the present embodiment.

In the coded stream reproduction device 100, when the operation receiving unit 108 detects an operation from the user for reproducing the stream A, the operation receiving unit 108 notifies the control unit 107 of the detection (Step S101). Then, the processing continues at Step S102.

Upon receipt of the notification from the operation receiving unit 108, the control unit 107 controls the data reading unit 102. The data reading unit 102 reads the image data corresponding to one picture included in the stream A stored in the recording medium 101, and outputs the read image data to the decoding unit 104 and the corresponding data detecting unit 103 (Step S102). Then, the processing continues at Step S103 and Step S104.

Based on the control by the control unit 107, the decoding unit 104 decodes the image data read by the data reading unit 102, and outputs the decoded image data to the decoded image accumulating unit 105 (Step S103). Then, the processing continues at the Step S105.

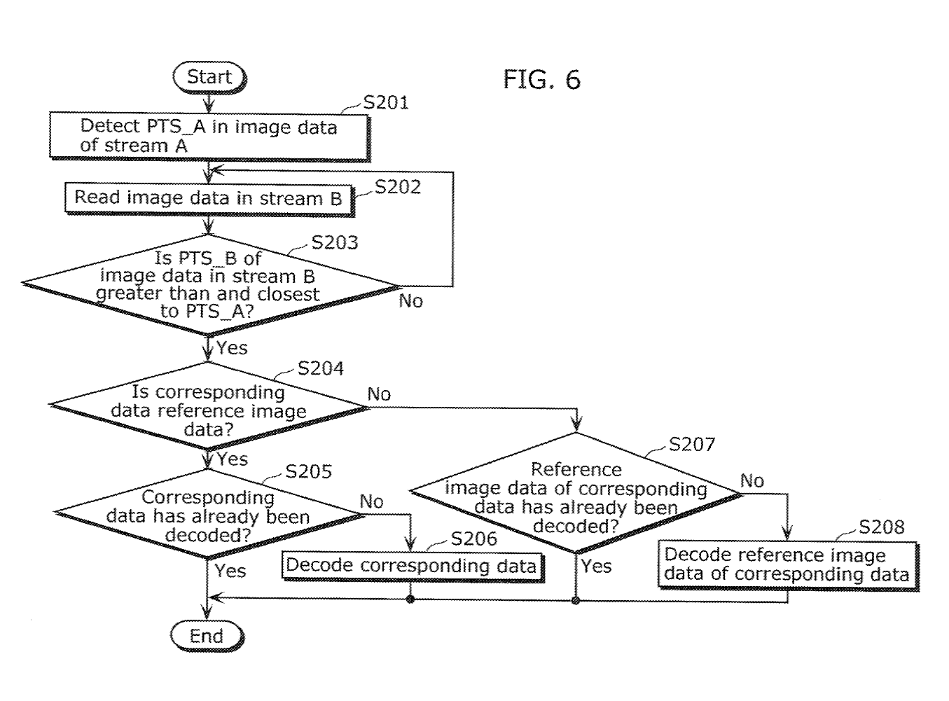

Based on the control by the control unit 107, the decoding unit 104 decodes, in parallel with Step S103, the image data included in the stream B corresponding to the read image data in the stream A, and outputs the generated decoded picture to the decoded image accumulating unit 105 (Step S104). Then, the processing continues at Step S105. The decoding processing of the image data included in the stream B will be later described in detail with reference to FIG. 6.

The control unit 107 may perform Step S103 and Step S104 in parallel, perform Step S103 after Step S104, or perform Step S104 after Step S103.

Based on the control by the control unit 107, the decoded image accumulating unit 105 accumulates the decoded picture generated when the decoding unit 104 decodes image data (Step S105). Then, the processing continues at Step S106.

The control unit 107 determines whether or not an operating signal for switching coded streams is being output by the output selecting unit 109 (Step, S106). In the case where an operating signal for switching the coded streams is not being output (Yes in Step S106), the processing continues at Step S107. In the case where the operating signal is being output (No in Step S106), the processing continues at Step S109.

Based on the control by the control unit 107, the output unit 106 reads the decoded picture corresponding to the stream A from the decoded image accumulating unit 105, and outputs the read decoded picture (Step S107). Then, the processing continues at Step S108.

The control unit 107 determines the end of the reproduction operation of the coded stream (Step S108). When it is determined that the reproduction is to be ended (Yes in Step S108), the operation ends. On the other hand, in the case where it is determined that the reproduction operation is to be continued (No in Step S108), the processing returns to Step S102, and the same operation is repeated. The determination of the end of the reproduction operation may be made by the control unit 107, or the coded stream reproduction device 100 may include a separate determining unit for making the determination.

On the other hand, in the case where an operating signal for switching the coded streams (No in Step S106), the output unit 106 determines, based on the control by the control unit 107, whether or not the decoded picture to be output is accumulated in the decoded image accumulating unit 105 (Step S109). When determined that the decoded picture to be output is accumulated (Yes in Step S109), the processing continues at Step S107. When determined that the decoded picture to be output is not accumulated (No in Step S109), the processing continues at Step S110. The determination may be made by the control unit 107, or the coded stream reproduction device 100 may include a separate determining unit for making the determination.

When determined that the decoded picture to be output is not accumulated (No in Step S109), the control unit 107 controls the decoding unit 104. The decoding unit 104 decodes, based on a decoded picture accumulated in the decoded image accumulating unit 105, a decoded picture to be output from the output unit 106, and outputs the decoded picture to the decoded image accumulating unit 105 (Step S110). Then, the processing continues at Step S107.

(Operation of the Decoding Unit 104 when Decoding the Stream B)

Next, reference is made to the operation when the decoding unit 104 decodes image data included in the stream B, with reference to the drawings. It is assumed that PTS_A is the PTS included in the image data of the stream A read by the data reading unit 102, and PTS_B is the PTS included in the image data of the stream B read by the data reading unit 102.

FIG. 6 is a flowchart showing an example of the decoding processing of a coded stream that is not being reproduced, out of the reproduction operation performed by the coded stream reproduction device 100 according to the present embodiment.

First, based on the control by the control unit 107, the corresponding data detecting unit 103 detects the PTS_A of the image data read by the data reading unit 102 in Step S102 (Step S201). Then, the processing continues at S202.

Next, based on the control by the control unit 107, the data reading unit 102 reads the image data included in the stream B from the recording medium 101 (Step S202). Then, the processing continues at Step S203.

Based on the control by the control unit 107, the corresponding data detecting unit 103 compares the PTS_A detected in Step S201 with the PTS_B in the image data in the stream B read in Step S202 (Step S203). In the case where the PTS_B is PTS later than and closest to the PTS_A (Yes in Step S203), the corresponding data detecting unit 103 outputs, as the corresponding data, image data having the PTS_B to the decoding unit 104. Then, the processing continues at Step S204. When not (No in Step S203), the processing returns to Step S202, and the data reading unit 102 reads next image data included in the stream B.

Next, based on the control by the control unit 107, the decoding unit 104 determines, from the nal_ref_idc included in the header of the corresponding data output in Step S203, whether or not the image data is reference image data (Step S204). When the corresponding data is reference image data (Yes in Step S204), the processing continues at Step S205. When the corresponding data is not reference image data (No in Step S204), the processing continues at Step S207.

When it is determined that the corresponding data is reference image data (Yes in Step S204), the control unit 107 determines whether or not the corresponding data has been decoded (Step S205). When the corresponding data has been decoded (Yes in Step S205), the operation ends. When the corresponding data has not been decoded (No in Step S205), the processing continues at Step S206. Note that the determination of whether or not the corresponding data has been decoded may be made using the header information included in the image data, such as PTS included in the corresponding data.

Based on the control by the control unit 107, the decoding unit 104 decodes the corresponding data output in Step S203, and ends the operation (Step S206).

When it is determined that the corresponding data is not reference image data (No in Step S204), the control unit 107 determines whether or not the reference image data corresponding to the corresponding data has been decoded (Step S207). When it is determined that the reference image data corresponding to the corresponding data has been decoded (Yes in Step S207), the operation ends. When not (No in Step S207), the processing continues at Step S208.

In the case where it is determined that the reference image data has not been decoded (No in Step S207), the decoding unit 104 decodes, based on the control by the control unit 107, the reference image data, outputs the decoded data to the decoded image accumulating unit 105, and ends the operation (Step S208).

In Step S203, in the case where it is determined that the image data in the stream B read from the recording medium 101 is not the corresponding data, and where the image data can be reference image data, the control unit 107 may store the recording location of the image in the recording medium 101. In this way, when the reference image is decoded in Step S208, the reference image can be immediately read from the recording medium 101.

In the similar manner, in Step S203, in the case where it is determined that the image data in the stream B read from the recording medium 101 is not corresponding data, and where the image data can be reference image data, it may be that information related to the decoding order and the display order of each image data is read from the header information, or calculated so that the control unit 107 stores the resultant. With this, when detecting and decoding a reference image in Step S206 to S208 and when the selection of the reference image is executed based on information of the decoding order or the display order, information can be used which is related to the decoding order and the display order of each image data stored in the control unit 107.

Alternatively, in Step S202, the control unit 107 may store the PTS_B of each image data in the stream B read from the recording medium 101. In this way, in the case where the image data in the stream B that has already been read includes corresponding data, it is possible to immediately detect the corresponding data in Step S203.

The coded stream reproduction device 100 according to the present embodiment reads image data corresponding to one picture included in the stream A from the recording medium 101, and detects, as corresponding data, image data included in the stream B having display time which is later than and closest to the display time of the read image data. In the case where the detected corresponding data is reference image data, the corresponding data can be decoded and accumulated. In the case where the detected corresponding data is not reference image data, reference image data corresponding to the corresponding data can be decoded and accumulated.

With this, in the case where a seamless switching of two coded streams shown in to be performed, the stream B needs to be decoded in parallel with the decoding of the stream A that is being reproduced. However, it is sufficient to decode only about ⅓ of entire pictures in the stream B (in the example of FIG. 3, mainly I-pictures and P-pictures); and thus, a seamless switching of streams can be achieved with a low processing capability.

In the present embodiment, the operations of the coded stream reproduction device 100 have been described based on the example where tow coded streams having different frame rates are switched; however, even when coded streams having a same frame rate are switched or when three or more coded streams are switched, stream switching can be achieved with a relatively low processing capability by the same method.

Furthermore, in the present embodiment, it has been described that the reproduction of a coded stream having a lower frame rate is switched to a coded stream having a higher frame rate; however, the present invention is not limited to such a structure, and it may be that the reproduction is switched from a coded stream having a higher frame rate to a coded stream having a lower frame rate. In this case, for example, as shown in FIG. 3, when the reproduction is switched from the B-picture 202 to the B-picture 203, it may be that the reproduction is immediately switched from the B-picture 202 to the B-picture 203. Alternatively, it may be that after reproduction up to the P-picture 208 is performed, switching to the B-picture 203 is performed. It may also be that after the reproduction is performed up to a picture between the B-picture 202 and the P-picture 208, switching to the B-picture 203 is performed. With such structure, even when the reproduction is switched from a coded stream having a higher frame rate to a lower frame rate, seamless switching of coded streams can be achieved.

As described, the coded stream reproduction device according to the embodiment of the present invention can smoothly switch the reproduction of a plurality of coded streams with a relatively low processing capability.

The coded stream reproduction device and the coded stream reproduction method have been described based on the embodiment; however, the present invention should not limited to the embodiment. Those skilled in the art will readily appreciate that many modifications are possible in the exemplary embodiment without materially departing from the novel teachings and advantages of this invention. Accordingly, all such modifications are intended to be included within the scope of this invention.

For example, it has been described in the present embodiment that the coded stream reproduction device 100 reads coded streams stored in the recording medium 101; however, the coded streams may be obtained via a communication line such as a network.

Note that the coded stream reproduction device 100 according to the present invention may include a CPU (Central Processing Unit), a system LSI (Large Scale Integration), a RAM (Random Access Memory), a ROM (Read. Only Memory), an HDD (Hard Disk Drive), a network interface, and so on. In addition, the coded stream reproduction device 100 may include a drive device which is capable of reading from and writing to a portable recording medium such as a DVD-RAM, a Blu-ray disc, an SD (Secure Digital) memory card.

Also note that the coded stream reproduction device 100 may be an embedded system such as a digital video camera, a digital recorder, a digital television, a game console, and a mobile phone.

Furthermore, a program for controlling the coded stream reproduction device 100 (hereinafter, referred to as a coding program) may be installed in the HDD, ROM, or the like, and each of functions of the coded stream reproduction device 100 may be achieved by executing the coding program.

The coding program may be recorded on a recording medium readable by a hardware system such as a computer system and an embedded system. Moreover, the coding program may be read by an other hardware system via the recording medium and executed. With this, each function of the coded stream reproduction device 100 can be achieved in the other hardware system. Here, examples of the recording medium readable by the computer system include an optical recording medium (e.g., a CD-ROM), a magnetic recording medium (e.g., a hard disk), a magneto-optical recording medium (e.g., an Magneto Optical disk (MO)), and a semiconductor memory (e.g., a memory card).

Furthermore, the coding program may be held by a hardware system connected to a network such as the Internet or a local area network. In addition, the coding program may be downloaded to another hardware system via the network and executed. With this, each function of the coded stream reproduction device can be achieved in the other hardware system. Here, examples of the network include a terrestrial broadcast network, a satellite broadcast network, PLC (Power Line Communication), a mobile phone network, a cable communication network (e.g., IEEE802.3), and a wireless communication network (e.g., IEEE802.11).

Note that the coded stream reproduction device 100 may be formed in a full-custom LSI, a semi-custom LSI such as an ASIC (Application Specific Integrated Circuit), a programmable logic device such as a FPGA (Field Programmable Gate Array) and a CPLD (Complex Programmable Logic Device), or a dynamic reconfigurable device which is capable of dynamically rewriting a circuit configuration.

Moreover, design data for forming each function of the coded stream reproduction device 100 in a coded stream reproducing integrated circuit may be a program described in a hardware description language (hereinafter, referred to as an HDL program). Furthermore, the design data may be a netlist at a gate level which is obtained by performing logic synthesis on the HDL program. Moreover, the design data may be macro-cell information in which configuration information, process conditions, and the like are added to the netlist at the gate level. Furthermore, the design data may be mask data in which size, timing, and the like are prescribed. Here, examples of the hardware description language include VHDL (Very high speed integrated circuit Hardware Description Language), Verilog-HDL, and System C.

The design data may be recorded on a recording medium readable by a hardware system such as a computer system or an embedded system. Moreover, the design data may be read by another hardware system via the recording medium and executed. The design data read by the other hardware system via the recording medium may be downloaded to the programmable logic device via a download cable.

Furthermore, the design data may be held by a hardware system connected to a network such as the Internet and a local area network. In addition, the design data may be downloaded to another hardware system via the network and executed. The design data acquired by the other hardware system via the network may be downloaded to the programmable logic device via the download cable.

Alternatively, the design data may be recorded on a serial ROM so that the design data is transferred to the FPGA when the power is on. The design data recorded on the serial ROM may be directly downloaded to the FPGA when the power is on.

Alternatively, when the power is on, the design data may be generated by a microprocessor and downloaded to the FPGA.

### INDUSTRIAL APPLICABILITY

The coded stream reproduction device according to the present invention provides an advantageous effect where reproduction of a plurality of coded streams can be smoothly switched with a relatively low processing capability. For example, the coded stream reproduction device according to the present invention is useful in a coded stream reproduction device which decodes a plurality of streams having different frame rates.

### REFERENCE SIGNS LIST

11 TS packet
12 PES packet
13 PCR
14 PES packet header
15 PES packet payload
16 NAL unit
100 Coded stream reproduction device
101, 401 Recording medium
102, 402 Data reading unit
103 Corresponding data detecting unit
104 Decoding unit
105 Decoded image accumulating unit
106 Output unit
107 Control unit
108, 409 Operation receiving unit
109, 408 Output selecting unit
110 Internal buffer
201, 207, 311 I-picture
202, 203, 204, 205, 312 B-picture
206, 208 P-picture
301, 302 Display picture
400 Image decoding device
403 De-multiplexing unit
404 First image decoding unit
405 Second image decoding unit
406 Image accumulating unit
407 Output switching unit
410 Display unit

1. A coded stream reproduction device which reproduces one of a plurality of coded streams, said coded stream reproduction device comprising:
a selecting unit configured to select one of the coded streams;
an obtaining unit configured to obtain a first coded stream and a second coded stream from the coded streams, the first coded stream being selected by said selecting unit, the second coded stream not being selected by said selecting unit;
a decoding unit configured to decode a first coded picture included in the first coded stream to generate a first decoded picture; and
a corresponding data detecting unit configured to detect a second coded picture from the second coded stream based on time information indicating a display time of the first decoded picture, the second coded picture being used for temporally-smooth switching of a display from the first coded stream to the second coded stream,
wherein said decoding unit is further configured to decode at least one of (i) the second coded picture detected by said corresponding data detecting unit and (ii) a third coded picture to be referred to when decoding the second coded picture.

2. The coded stream reproduction device according to claim 1, further comprising:
an accumulating unit configured to accumulate the decoded picture generated by decoding by said decoding unit; and
an output unit configured to read, from said accumulating unit, the decoded picture generated from the coded stream selected by said selecting unit and to output the read decoded picture,
wherein said output unit is configured to output a second decoded picture generated by decoding the second coded picture corresponding to the first decoded picture that is being output when said selecting unit selects the second coded stream.

3. The coded stream reproduction device according to claim 2,
wherein said decoding unit is configured to generate the second decoded picture by decoding the second coded picture, in the case where the second coded picture is not decoded when said selecting unit selects the second coded stream, the second coded picture corresponding to the first decoded picture output by said output unit.

4. The coded stream reproduction device according to claim 1,
wherein said corresponding data detecting unit is configured to detect, as the second coded picture, a picture having time information indicating a time within a predetermined period from the display time indicated by the time information of the first decoded picture.

5. The coded stream reproduction device according to claim 4,
wherein said corresponding data detecting unit is configured to detect, as the second coded picture, a picture having time information indicating a time that is later than and closest to the display time indicated by the time information of the first decoded picture.

6. The coded stream reproduction device according to claim 4,
wherein said corresponding data detecting unit is configured to detect, as the second coded picture, a picture having time information indicating a time within a period from the display time indicated by the time information of the first decoded picture, the period indicating a period between continuous coded pictures of the first coded stream or the second coded stream.

7. The coded stream reproduction device according to claim 6,
wherein the first coded stream has a frame rate lower than a frame rate of the second coded stream, and
said corresponding data detecting unit is configured to detect, as the second coded picture, a picture having time information indicating a time later than the display time and within a period from the display time, the display time being indicated by the time information of the first decoded picture, the period being a period between continuous coded pictures of the first coded stream.

8. The coded stream reproduction device according to claim 1,
wherein said decoding unit is configured to decode the second coded picture in the case where the second coded picture is a reference picture to be referred to when another coded picture is decoded.

9. The coded stream reproduction device according to claim 1, wherein said decoding unit is configured to decode the third coded picture in the case where the second coded picture is not a reference picture to be referred to when another coded picture is decoded and the third coded picture has not been decoded.

10. A coded stream reproduction method for reproducing one of a plurality of coded streams, said coded stream reproduction method comprising:
selecting one of the coded streams;
obtaining a first coded stream and a second coded stream from the coded streams, the first coded stream being selected in said selecting, the second coded stream not being selected by said selecting;
decoding a first coded picture included in the first coded stream to generate a first decoded picture; and
detecting a second coded picture from the second coded stream based on time information indicating a display time of the first decoded picture, the second coded picture being used for temporally-smooth switching of a display from the first coded stream to the second coded stream,
wherein, in said decoding, at least one of (i) the second coded picture detected in said detecting and (ii) a third coded picture to be referred to when decoding the second coded picture is further decoded.

11. A non-transitory computer-readable recording medium for use in a computer, said recording medium having a computer program recorded thereon for causing the computer to execute the coded stream reproduction method according to claim 10.

12. A coded stream reproduction integrated circuit which reproduces one of a plurality of coded streams, said coded stream reproduction integrated circuit comprising:
a selecting unit configured to select one of the coded streams;
an obtaining unit configured to obtain a first coded stream and a second coded stream from the coded streams, the first coded stream being selected by said selecting unit, the second coded stream not being selected by said selecting unit;
a decoding unit configured to decode a first coded picture included in the first coded stream to generate a first decoded picture; and
a corresponding data detecting unit configured to detect a second coded picture from the second coded stream based on time information indicating a display time of the first decoded picture, the second coded picture being used for temporally-smooth switching of a display from the first coded stream to the second coded stream,
wherein said decoding unit is further configured to decode at least one of (i) the second coded picture detected by said corresponding data detecting unit and (ii) a third coded picture to be referred to when decoding the second coded picture.
